(19) United States
(12) Patent Application Publication
(10) Pub. No.: US 2022/0398663 A1
(43) Pub. Date: Dec. 15, 2022

(54) INVESTMENT ADVICE PROVIDING METHOD AND SYSTEM

(71) Applicant: KATOH, Hironobu, Tokyo (JP)

(72) Inventor: Hironobu KATOH, Tokyo (JP)

(21) Appl. No.: 17/764,415

(22) PCT Filed: Jun. 16, 2020
(86) PCT No.: PCT/JP2020/023534

§ 371 Date: Mar. 28, 2022

(51) Int. Cl. G06Q 40/06; G06Q 30/02

(52) U.S. Cl. CPC G06Q 40/06; G06Q 30/0202

(57) ABSTRACT

The present technology makes it possible to provide investment advice for a user based on the user's own forecast.

The present technology includes, for example, a method for providing investment advice for a user in a computer, wherein the computer receives a current market forecast and a user forecast for economic indicators or corporate performance and a user's investment policy, simulates an investment result predicted from the current market forecast and the user forecast using a prediction model machine-learned based on past market forecasts and user forecasts, and from among predicted investment results, outputs a result that satisfies the user's investment policy.

### TECHNICAL FIELD

The present technology relates to a method and system for providing advice on investment.

### BACKGROUND ART

International Publication No. WO 2019/082274 discloses a technology in which a market forecast is calculated from a plurality of user forecast values, a deviation value between a specific user forecast value and the market forecast is calculated, and an alert is sent when the deviation value is equal to or greater than a predetermined value, for the purpose of making it possible for a large number of users to easily share and manage the performance forecast of a company and for making stock investment recommendations that respect the performance forecast of each user including individuals and small investors.

International Publication No. WO 2019/186988 discloses a technology for calculating a theoretical stock price by using a predicted value and multiple of a user and transmitting an alert when the current stock price read out from a database and the theoretical stock price deviate by a predetermined value or more, for the purpose of supporting a stock price prediction by referring to past performance and stock prices based on a performance forecast of a company by the user himself/herself.

International Publication No. WO 2020/084733 discloses a technique for managing quarterly progress against annual planned values of corporate performance and for easily comparing the results with predicted values by users during the same period, wherein planned values of corporate performance in a second period, in which a first period is divided proportionally, are calculated based on planned values of corporate performance in a first period, the planned values of corporate performance in the second period are compared with predicted values of corporate performance by users in the second period, and an alert is sent when the planned values of corporate performance in the second period and predicted values by users deviate by a predetermined value or more.

### CITATION LIST

### Patent Literature

Patent Literature 1: International Publication No. WO 2019/082274
Patent Literature 2: International Publication No. WO 2019/186988
Patent Literature 3: International Publication No. WO 2020/084733

### SUMMARY OF INVENTION

### Technical Problem

A method and system for providing investment advice for a user based on the user's own forecast is desired.

A method and system for providing investment advice based on a user's own past investment results is desired.

A method and system for providing investment advice consistent with a user's own investment policy is desired.

A method and system for providing investment advice based on a user's own predicted investment results is desired.

A method and system for providing investment advice that reflects user feedback is desired.

### SOLUTION TO PROBLEM

The present technology includes, for example, a method for providing investment advice for a user in a computer, wherein the computer receives a current market forecast and user forecast for economic indicators or corporate performance and a user's investment policy, simulates investment results predicted from the current market forecast and user forecast using a prediction model machine-learned based on past market forecasts and user forecasts and the investment results resulting from these forecasts, and outputs predicted investment results satisfying the user's investment policy.

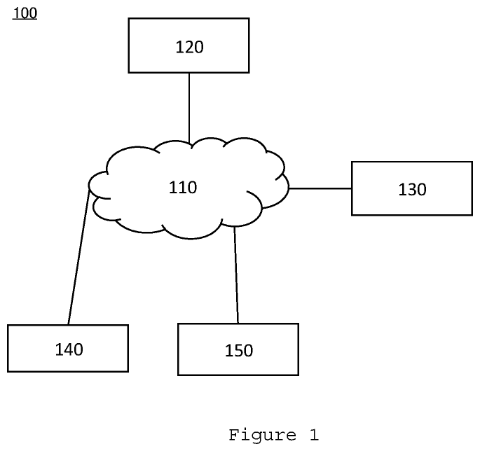

FIG. 1 is a diagram showing an investment advice providing system according to an embodiment of the present technology according to an embodiment of the present technology.

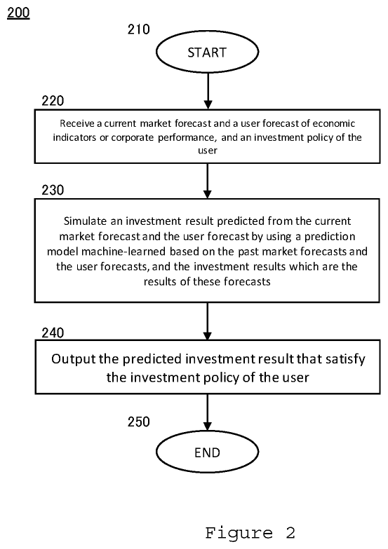

FIG. 2 is a flow chart showing a method of providing investment advice according to an embodiment of the present technology.

### DESCRIPTION OF EMBODIMENTS

FIG. 1 shows an investment advice providing system 100 according to an embodiment of the present technology.

The investment advice providing system 100 includes a server 120, a storage device 130, and clients 140 and 150 connected to the network 110.

The network 110 may be the Internet, a private network, a virtual private network (VPN), a local area network (LAN), a fifth-generation mobile communication system (5G), or a combination thereof. The network 110 may be wired or wireless, or a combination thereof.

The server 120 is a computer having a processor (not shown), a memory (not shown) storing a program, and a communication function (not shown). The server 120 reads data from and writes data to the storage device 130 either over the network 110 or directly. The server 120 executes the program stored in the memory in response to the request from the client 140 or 150 and returns the result to the client 140 or 150.

The storage device 130 is a storage device accessible from the server 120 via the network 110 or directly. Storage device 130 may be network attached storage (NAS) or cloud storage, or may be a hard disk drive (HDD) or solid state drive (SSD) stored in the same enclosure as server 120.

The client 140 or 150 is a computer, a tablet terminal, a smartphone, or the like having a function of communicating with the server 120 via a network 110 connected by wire or wireless. Although two clients 140 or 150 are depicted in FIG. 1, one or more clients may be present.

FIG. 2 shows a method of providing investment advice according to an embodiment of the present technology with reference to FIG. 1.

In FIG. 2, in step 210, an investment advice providing method 200 is initiated at the server 120. Next, in step 220, the server 120 receives from the client 140 or 150 a current market forecast and a user forecast for economic indicators or corporate performance, and a user's investment policy. If current market and user forecasts of economic indicators or corporate performance, and all or part of user investment policies are stored in the storage device 130, the server 120 may read all or part of the information from the storage device 130 and accept the information.

Economic indicators are numerical measurements of metrics that constitute the economic situation (such as prices, interest rates, the economy, and trade) released by public institutions in each country. They can accurately capture the current state of the economy and changes from the past. They may be policy interest rates, Gross Domestic Product (GDP), business confidence surveys, consumption trends, employment statistics, price trends, fiscal policy, housing statistics, orders statistics, trade balance, or a combination thereof.

An enterprise performance is the performance of an individual enterprise and may be an enterprise's sales, operating revenues, gross profits, operating income, recurring income, earnings before taxes, net income, earnings per share, earnings before interest and taxes (EBIT), earnings before interest, taxes, depreciation, and amortization (EBITDA), dividends, or combinations thereof.

The forecast may be for multiple periods, such as by year or quarter. The forecast may also be a forecast for a stock price.

The market forecast may be an average of a plurality of user forecasts, an average of a plurality of analyst forecasts, or an average or weighted average thereof. In this specification, the term “analyst” includes not only security analysts but also newspaper reporters and investors who are not users.

The user forecasts may be forecasts made by the user herself/himself or may utilize forecasts made by other users or analysts. The user forecast may include a confidence level indicating the user's own degree to the forecast. The confidence level may be expressed as a numerical value of 0 to 100%, or may be expressed in stages such as “Yes”, “No” or “Neither”. Also, the user forecast and confidence level may be modified any number of times before the performance is announced.

The current forecast may be the latest forecast, and can be the forecast for the day, week, month, quarter, or year to which the forecast was made.

The user's investment policy may be an investment amount or a planned investment amount indicating how much the user wants to invest in total, the number of securities the user wants to diversify in, the asset class, the target annual return or the target benchmark, the risk tolerance level indicating acceptable loss amount or percentage, or a combination thereof. If the user is a fund manager, this may include investment policies (e.g., investing in domestic stocks and bonds) and investment parameters (e.g., not trading futures and options) of the fund.

Next, in step 230, the server 120 simulates the investment results predicted from the current market and user forecasts using a machine-learned prediction model based on past market and user forecasts and the investment results resulting from these forecasts.

The prediction model machine-learned based on the past market forecasts and user forecasts, and the investment results as the results of these forecasts may be a model that is supervised learned (including semi-supervised learning and reinforcement learning in this specification) by a network model such as a convolutional neural network, or may be a deep learning model that is unsupervised learned based on the past market forecasts and user forecasts, using the correspondence relationship between the past market forecasts and the user forecasts, and the forecasts and the market results as data.

The investment result may be, for example, an asset class, a security, an investment period, a buy/sell/short sale, number of securities or value transacted, a transaction method, or a combination thereof. The investment results may include multiple asset classes, securities, investment periods, buys/sells, transaction volume or value, and transaction methods.

For example, for the quarter reporting one year later, assume Company A's earnings per share is expected to be 2% increase by the market, below the 3% increase expected for the benchmark such as S&P500, while the user forecasts a 4% increase. One year later, the actual profit growth rate is below the benchmark, and the investment result may be that Company A shares increased x %, below the benchmark price increase of Y %. In this case, it may be concluded that the user's forecast is not accurate because although the user gained X % from Company A's share price increase, that gain was smaller than the benchmark gain of Y %.

The investment results may include past performance based on the user forecast. The past performance may be the accuracy of the user forecast, the realized profit based on the user forecast, user's confidence level to the forecast and a result, or a combination thereof.

Investment results may include market and user forecasts and investment result before and after a past event such as earnings announcement, new product announcement, monthly sales announcement, etc.

The simulation may also be performed using (1) past and current prices, (2) upcoming events, (3) liquidity, and (4) track record of the user.

(1) Past and current prices may be stock prices, bond prices, option prices, credit default swap (CDS) prices, exchange rates, and exchange traded funds (ETF) prices. A large change in the absolute value or relative value of these prices may be calculated to identify a trigger of the change (for example, an event such as earnings announcement, a new product announcement, or a monthly announcement). The past and present prices may include absolute or relative values of past prices, PER (Price Earnings Ratio), PBR (Price-Book Value Ratio), EV (Enterprise Value)/EBITDA (Earnings Before Interest, Taxes, Depreciation, and Amortization), etc.

(2) Future events may be predicted based on a company's announcement schedule or a past schedule pattern (for example, since T Company announces monthly sales at the beginning of each month, we can assume that it will continue to announce monthly sales on the same schedule).

(3) Liquidity may be the daily amount of shares traded, the daily amount of bonds traded, or the daily amount of securities offered by securities companies (I. e., the amount of bids/asks). For example, the appropriate trading volume for today or tomorrow may be estimated from the trading amount of the previous business day, the average of the past five business days, and the average of the past twenty business days, and the like. Also, in order to trade without significantly impacting the market price, the appropriate trading volume may be set at 5 to 10% or less of the total trading volume in the market.

(4) A user's track record may be (a) whether user's forecasts of economic indicators and company performance are more accurate compared with those of other users (accuracy), (b) whether investment decisions based on the user's forecasts have led to positive returns, (c) the user's confidence and results, (d) market consensus, or a combination thereof.

(a) Whether or not user's forecasts of economic indicators and corporate performance compare favorably with those of other users (accuracy) may be calculated on the basis of all forecasts or on the basis of individual company or economic indicators.

(b) Whether or not the investment decision based on the user's forecast has led to profits may be whether or not the user has actually made the investment, the timing at which the investment was made and the result of the execution (whether or not the user has been able to make a transaction at the target price, whether or not the user has been able to make a transaction satisfying the target amount, etc.), the investment timing (for example, if the user expects a profit increase in the current term but a profit decrease in the next term, then when would the peak be reached and the user should start selling), or a combination thereof.

(c) The user's confidence and results may be: whether the user's forecast is likely to be correct when confident; whether it is closer to market consensus when confident; whether it is more frequent to be correct when the user's forecast is far from market consensus; whether if the market forecast gets closer to the user's forecast or the user's forecast gets closer to the market forecast when the user's forecast is far from market consensus; whether it was profitable to invest when confident; or a combination thereof.

(d) Market consensus may be the correlation between market consensus and stock price (security price).

Next, in step 240, the server 120 outputs a predicted investment result satisfying the investment policy of the user.

For example, a plurality of investment results may be obtained by simulation, and whether or not each of the investment results satisfies the user's investment policy may be compared and determined, and the investment results satisfying the user's investment policy may be output as investment advice and transmitted to the client 140 or 150.

For example, if one of the investment results obtained by the simulation is to purchase Company B stock to expect a 3% annualized return after selling it in six months, the investment result may be outputted if the user's investment policy is to obtain a return of 2% or more per annum, and the investment result may not be outputted if the user's investment policy is to obtain a return of 4% or more per annum.

When a plurality of investment results satisfying the investment policy of the user are obtained, the output may be displayed in the descending order of the profit ratio, the output may be displayed in the ascending order of the risk, or the output may be displayed in any order.

On the other hand, when an investment result satisfying the user's investment policy is not obtained, a result which does not satisfy the user's investment policy but is close to the user's investment policy may be output.

The predicted investment result satisfying the user's investment policy may be output as an asset class, an issue, an investment period, a buy or sell, a transaction amount of shares or transaction amount of money, a transaction method, or a combination thereof.

Further, the server 120 may receive user feedback on the output predicted investment result from the client 140 or 150 and utilize the predicted investment result and feedback as teacher data.

The feedback may include whether or not the investment was made according to the predicted investment result, and may include the reason why the investment was not made according to the predicted investment result output.

The feedback may be, for example, (1) good (I. e., placing an order with a securities company), (2) different timing, (3) different basis for advice, (4) a change in confidence in the user's forecast, or (5) a change in the user's forecast. As a result of placing an order, (6) the order was executed as scheduled, (7) the budget was insufficient, (8) there was no access to securities (no access from securities companies, different accounts, different regions, etc.), (9) the timing was missed, (10) the order was not filled at the limit price, (11) there was no liquidity, and (12) user changed mind and cancelled the order (there was a change in confidence or the user's forecast, etc.).

Next, in step 250, the investment advice providing method 200 ends.

### INDUSTRIAL APPLICABILITY

The present technology makes it possible to provide investment advice for a user based on the user's own forecast.

### REFERENCE SIGNS LIST

100 Investment Advice Providing System
110 network
120 server
130 storage device
140, 150 clients

1-19. (canceled)

20. A method for providing investment advice for a user in a computer comprising:
receiving a current market forecast and the user's own forecast of economic indicators or corporate performance, and an investment policy of the user including at least one of investment amount or planned investment amount, number of securities, asset class, target annual return, benchmark and risk tolerance;
simulating an investment result predicted from the current market forecast and the user's own forecast by using a prediction model machine-learned based on the past market forecasts and the user's own forecasts, and the user's own investment results which are the results of these forecasts; and
outputting the predicted investment result that satisfy the investment policy of the user.

21. The method for providing investment advice according to claim 20,
wherein the economic indicators include values for at least one of policy interest rates, Gross Domestic Product (GDP), business confidence surveys, consumption trends, employment statistics, price trends, fiscal policy, housing statistics, orders received statistics, and trade balance; and
wherein the performance of the enterprise includes values for at least one of sales, operating revenues, gross profits, operating income, recurring income, income before taxes, net income, earnings per share, earnings before interest and taxes (EBIT), earnings before interest, taxes, depreciation, and amortization (EBITDA), and dividends of the enterprise.

22. The method for providing investment advice according to claim 20, wherein the market forecast includes an average or weighted average of a plurality of user or analyst forecasts.

23. The method for providing investment advice according to claim 20 further comprising:
comparing whether the predicted investment result satisfies the investment policy of the user.

24. The method for providing investment advice according to claim 20, wherein the investment policy includes investment parameters of a fund.

25. The method for providing investment advice according to claim 20, wherein the investment result includes at least one of an asset class, a security, an investment period, a buy/sell, a transaction amount of shares or a transaction value, and a transaction method.

26. The method for providing investment advice according to claim 20, wherein the investment results further include past performance based on the user forecast.

27. The method for providing investment advice according to claim 26, wherein the past performance includes at least one of accuracy of the user forecast, a realized profit based on the user forecast, a confidence level of the user forecast, or a result.

28. The method for providing investment advice according to claim 20, wherein the investment result further includes a market forecast and a user forecast and an investment result before and after a past event.

29. The method for providing investment advice according to claim 20, wherein a prediction model machine-learned based on the past market forecasts and the user forecasts, and the investment results include a supervised learning model using the correspondence relationship between the past market forecasts and the user forecasts, and the forecasts and the market results as data.

30. The method for providing investment advice according to claim 20, wherein a prediction model machine-learned based on the past market forecasts and the user forecasts, and the investment result includes a deep learning model learned based on the past market forecasts and the user forecasts.

31. The method for providing investment advice according to claim 30, wherein the learning comprises unsupervised learning.

32. The method for providing investment advice according to claim 20, wherein the user's investment policy includes liquidity including an appropriate trading volume per day.

33. The method for providing investment advice according to claim 20,
wherein the computer receives feedback from the user on the output predicted investment result; and
wherein the past market and user forecasts and investment results further comprise the output forecast investment result and the feedback.

34. The method for providing investment advice according to claim 33, wherein the feedback of the user includes whether or not the investment was made in accordance with the output predicted investment result.

35. The method for providing investment advice according to claim 33, wherein the user feedback includes a reason why the investment was not made according to the output predicted investment result.

36. The method for providing investment advice according to claim 20, wherein the forecasted investment results meeting the investment policy include at least one of an asset class, a security, an investment period, a buy or sell, transaction amount of shares or transaction amount of money, or transaction method.

37. A system for providing advice on investments of users, comprising:
a client configured to transmit a user's forecast of economic indicators or corporate performance and an investment policy of the user including at least one of investment amount or planned investment amount, number of securities, asset class, target annual return, benchmark and risk tolerance; and
a server configured to store a current market forecast for economic indicators or corporate performance and receive the user's own forecast and the user's investment policy,
wherein the server is further configured to:
simulate an investment result predicted from the current market forecast and the user's own forecast by using a prediction model machine-learned based on the past market forecasts and the user's own forecasts, and the use's own investment results, and
transmit the predicted investment result satisfying the investment policy of the user to the client.

38. A computer-readable recording medium which have recorded therein a program that causes a server to execute the following comprising:
receiving a current market forecast and a user forecast regarding economic indicators or corporate performance, and the investment policy of the user including at least one of investment amount or planned investment amount, number of securities, asset class, target annual return, benchmark and risk tolerance; and
simulating an investment result predicted from the current market forecast and the user's own forecast using a prediction model machine-learned based on the past market forecasts and the user's own forecasts, and the user's own investment results.
